(19) United States
(12) Patent Application Publication
(10) Pub. No.: US 2009/0121580 A1
(43) Pub. Date: May 14, 2009

(54) Brush System for a Motor Vehicle Actuating Drive

(76) Inventor: Gerald Viernekes, Hassfurt (DE)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/092,362

(22) PCT Filed: Sep. 8, 2006
(86) PCT No.: PCT/EP2006/066160

§ 371 Date: Sep. 25, 2008

(30) Foreign Application Priority Data
Nov. 4, 2005 (DE) 10 2005 052 722.1

(51) Int. Cl. H01R 39/38

(52) U.S. Cl. 310/242

(57) ABSTRACT

A brush system for a motor vehicle actuating drive has two carbon brushes, of which each is fixed to a leaf spring. Each of the leaf springs is for its part fixed to a punched contact. Furthermore, the brush system contains a printed circuit board which has conductor tracks and on which interference suppression components are placed. Electrical contact is made with the leaf springs by in each case one of the conductor tracks.

### CROSS-REFERENCE TO RELATED APPLICATIONS

This application is a U.S. national stage application of International Application No. PCT/EP2006/066160 filed Sep. 8, 2006, which designates the United States of America, and claims priority to German application number 10 2005 052 722.1 filed Nov. 4, 2005, the contents of which are hereby incorporated by reference in their entirety.

### TECHNICAL FIELD

The invention relates to a brush system for a motor vehicle actuating drive as well as a motor vehicle actuating drive, which has a brush system of this type.

### BACKGROUND

Brush systems for motor vehicle actuating drives are already known. Brush systems of this type have a base body made of plastic, onto which the additional components of the brush system are fixed. The said additional components are flow guides, carbon brushes and interference suppression elements for instance.

DE 198 05 185 A1 discloses a drive apparatus which is provided in particular to adjust the sliding roof of a motor vehicle. This has an electromotor, which is provided with an armature with a commutator, which is accommodated in a terminal housing. The part lying outside the pole housing forms a gear drive shaft for a gearbox, which is accommodated in a gearbox housing connected to the pole housing. The gearbox housing receives a conductor board. This supports a brush holder, the brushes of which strike the commutator of the armature. The conductor board essentially extends its entire length at right angles to an armature shaft of the armature and at least partially covers the commutator of the armature. The brush holder engages in a recess of the gearbox housing provided in the region of the commutator. The brush holder has a base body made of plastic, which is provided with sleeve-like receptacles for interference suppression throttles. In addition, the brush holder has elements, which hold the brushes in an assembly position within a respective tubular brush holder in order to assemble the brush holder.

### SUMMARY

According to an embodiment, a new, simplified brush system for a motor vehicle actuating drive may comprise two carbon brushes, of which each is fastened to a leaf spring, wherein each of the leaf springs being fastened to a punched contact, and a printed circuit board, which has conductor tracks and upon which interference suppression components are positioned, wherein the leaf springs being electrically contacted to at least one conductor track in each instance.

According to a further embodiment, the printed circuit board may be provided with solder pads, the solder pads may be electrically contacted to a conductor track in each instance and the leaf springs may be electrically contacted to the solder pads. According to a further embodiment, the leaf springs may rest against the solder pads and may be pressed against the respective solder pad by prestressing the respective leaf spring. According to a further embodiment, the leaf springs can be made of springy sheet copper. According to a further embodiment, the punched contacts can be made of an electrically conductive material. According to a further embodiment, the leaf springs may be each fastened to punched contacts by means of a welded, screw or rivet connection.

According to another embodiment, a motor vehicle actuating drive may comprise a housing made of plastic, into which such a brush system is inserted. According to a further embodiment, the punched contacts of the brush system may be each provided with an appendage and these appendages of the punched contacts may be received in receiving elements of the housing. According to a further embodiment, the end regions of the leaf springs deposited by the printed circuit board can be guided through guide elements of the housing in each instance.

### BRIEF DESCRIPTION OF THE DRAWINGS

Further advantageous characteristics of the invention emerge from the exemplary explanation thereof on the basis of the figures, in which;

FIG. 1 shows a front view of a brush system according to an exemplary embodiment and

FIG. 2 shows a partial view of the housing of a motor vehicle actuating drive, into which the brush system according to FIG. 1 is inserted.

### DETAILED DESCRIPTION

The advantages according to various embodiments consist particularly in the external contacting of the conductor tracks of the printed circuit board, on which interference suppression components are provided, taking place by means of the leaf springs, on which the carbon brushes are disposed. This multifunction of the leaf springs dispenses with the need for additional fastening elements and thus additional connection processes, in order to realize the external contacting of the conductor tracks of the printed circuit board. This signifies a reduction in the components required to realize a brush system as well as a reduction in the number of connection processes to be implemented.

The leaf springs can be advantageously attached to solder pads, which are provided on the printed circuit board and are contacted with a conductor track of the printed circuit board in each instance. This attachment to the solder pads is herewith beneficial in that the leaf springs, which are preferably made of sheet copper, can be elastically deformed and do not relax. This ensures that the necessary pressing force is provided over the entire operating time and service life of the brush system.

A further advantage consists in it being possible to position the interference suppression components in the vicinity of the carbon brushes, which benefits the interference suppression process.

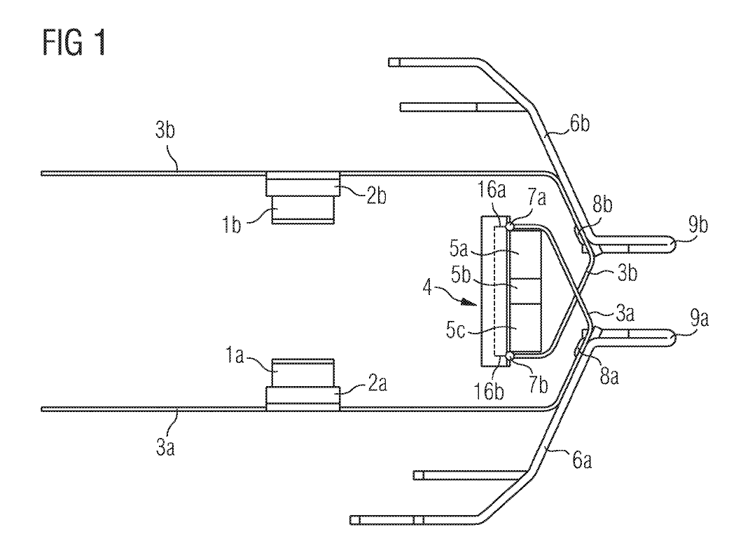

FIG. 1 shows a front view of a brush system according to an exemplary embodiment.

The brush system shown has carbon brushes 1a, 1b, which are positioned in positioning aids 2a, 2b. The carbon brush 1a is fastened to a leaf spring 3a made of sheet copper, the carbon brush 1b is fastened to a leaf spring 3b which is likewise made of sheet copper. These leaf springs can be deformed elastically and can maintain a prestressed state over a long period of time without relaxing.

The leaf spring 3a is fastened to a punched contact 6a, for instance by means of a welded, screw or rivet connection 8a. The leaf spring 3b is fastened to a punched contact 6b, for instance by means of a welded, screw or rivet connection 8b.

The punched contacts 6a and 6b are preferably made of an electrically conductive material, so that the carbon brushes are electrically contacted to the respective punched contact by way of the respective leaf spring.

The punched contact 6a is preferably provided with an appendage 9a in its right end region in the FIG. 1, by way of which it is contacted to an external current guide, for instance an electronic unit or a plug. The punched contact 6b is preferably provided with an appendage 9b in its right end region in the FIG. 1, by way of which it is likewise contacted to the external current guide.

In addition, the brush system shown in FIG. 1 also has a printed circuit board 4, which is used as a support for interference suppression components 5a, 5b, 5c. Conductor tracks 16a, 16b are provided inside the printed circuit board or on the surface thereof, by way of which conductor tracks the interference suppression components are interconnected with one another.

The printed circuit board 16a is also electrically connected to a solder pad 7a, which is provided on the printed circuit board 4. The conductor track 16b is electrically connected to a solder pad 7b, which is likewise provided on the printed circuit board 4.

One end of the leaf spring 3a rests on the solder pad 7a, and one end of the leaf spring 3b rests on the solder pad 7b. The conductor tracks 16a, 16b of the printed circuit board 4 are herewith outwardly electrically contacted by way of the solder pads 7a, 7b and the leaf springs.

It is sufficient for this external electrical contacting for the ends of the leaf springs 3a and 3b to rest on the solder pads, since no high outputs have to be transmitted for the interference suppression of the window lifting motor in a motor vehicle for instance. This ensures a continuous electrical contacting, such that the leaf springs are made of sheet copper. Sheet copper concerns a material, which can apply a pressing force throughout its entire service life, since the material can be elastically deformed and/or is springy and does not relax. Subsequently, the leaf springs made of sheet copper can assume the desired pressing function, without additional components being necessary. The advantages associated therewith consist in additional components being spared for an external electrical contacting of the conductor tracks of the printed circuit board and consequently no connecting processes in respect hereof being required during the manufacture of the brush system.

The punched contacts 6a, 6b contacted with the leaf springs 3a, 3b likewise preferably consist of an electrically conductive material. By way of example, these punched contacts 6a, 6b are arched lead frames.

The punched contact 6a, as was already mentioned above, and the punched contact 6b are outwardly electrically contacted by way of their appendages 9a, 9b respectively, for instance with an external electronic unit or a plug.

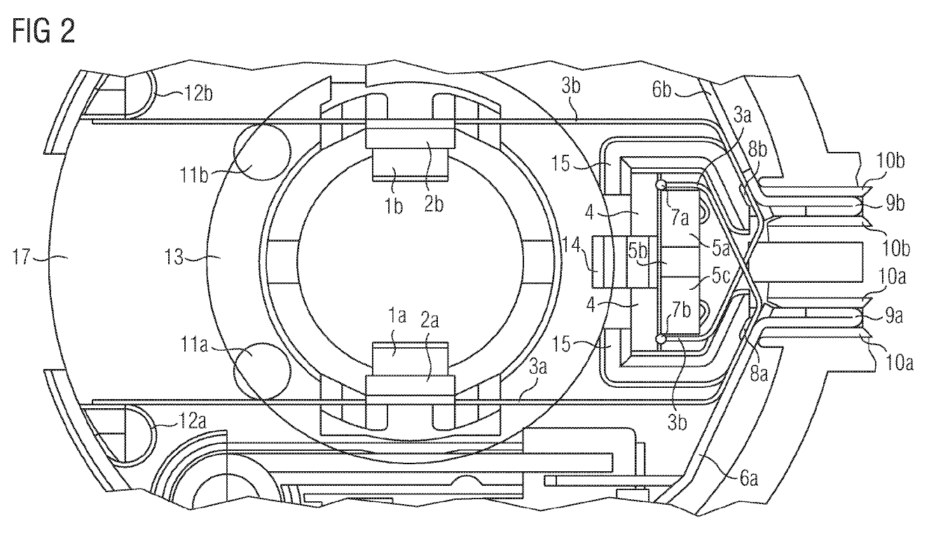

FIG. 2 shows a partial view of the housing of a motor vehicle actuating drive, into which the brush system according to FIG. 1 is inserted. FIG. 2 shows that the housing 17, which concerns a plastic housing, has an essentially round recess surrounded by a housing part 13 in its central region, through which the commutator of an electromotor is introduced during assembly of the actuating drive such that it comes to rest between the carbon brushes 1a and 1b. FIG. 2 also shows that the printed circuit board 4 is supported by holding elements 14 and 15, which are components of a printed circuit board pocket.

FIG. 2 also shows that the region of the leaf springs 3a, 3b disposed in the Figure on the left side of the carbon brushes 1a and 1b is guided through between guide elements 11a, 111b; 12a, 12b of the housing 17.

FIG. 2 finally shows that the appendages 9a, 9b of the punched contacts 6a, 6b have been introduced into receiving elements 10a, 10b of the housing 17, which form a receiving groove in each instance. The electrical contacting of the brush system can take place on and/or in these receiving elements in each instance using an external electronic unit or an external plug.

1. A brush system for a motor vehicle actuating drive, comprising:
two carbon brushes, of which each is fastened to a leaf spring, wherein
each of the leaf springs being fastened to a punched contact, and
a printed circuit board, which has conductor tracks and upon which interference suppression components are positioned,
wherein the leaf springs being electrically contacted to at least one conductor track in each instance.

2. The brush system according to claim 1, wherein the printed circuit board is provided with solder pads, the solder pads are electrically contacted to a conductor track in each instance and the leaf springs are electrically contacted to the solder pads.

3. The brush system according to claim 2, wherein the leaf springs rest against the solder pads and are pressed against the respective solder pad by prestressing the respective leaf spring.

4. The brush system according to claim 1, wherein the leaf springs are made of springy sheet copper.

5. The brush system according to claim 1, wherein the punched contacts are made of an electrically conductive material.

6. The brush system according to claim 1, wherein the leaf springs are each fastened to punched contacts by means of a welded, screw or rivet connection.

7. A motor vehicle actuating drive, comprising a housing made of plastic, into which a brush system is inserted, the brush system comprising:
two carbon brushes, of which each is fastened to a leaf spring, wherein each of the leaf springs being fastened to a punched contact, and
a printed circuit board, which had conductor tracks and upon which interference suppression components are positioned wherein the lead springs being electrically contacted to at least one conductor track in each instance.

8. The motor vehicle actuating drive according to claim 7, wherein the punched contacts of the brush system are each provided with an appendage and these appendages of the punched contacts are received in receiving elements of the housing.

9. The motor vehicle actuating drive according to claim 7, wherein the end regions of the leaf springs deposited by the printed circuit board are guided through guide elements of the housing in each instance.

10. The motor vehicle actuating drive according to claim 7, wherein the printed circuit board is provided with solder pads, the solder pads are electrically contacted to a conductor track in each instance and the leaf springs are electrically contacted to the solder pads.

11. The motor vehicle actuating drive according to claim 10, wherein the leaf springs rest against the solder pads and are pressed against the respective solder pad by prestressing the respective leaf spring.

12. The motor vehicle actuating drive according to claim 7, wherein the leaf springs are made of springy sheet copper.

13. The motor vehicle actuating drive according to claim 7, wherein the punched contacts are made of an electrically conductive material.

14. The motor vehicle actuating drive according to claim 7, wherein the leaf springs are each fastened to punched contacts by means of a welded, screw or rivet connection.

15. A method for providing a brush system for a motor vehicle actuating drive, comprising the steps of:
providing two carbon brushes;
fastened each carbon brush to a leaf spring,
fastened each leaf spring to a punched contact, and
providing a printed circuit board, which has conductor tracks;
positioning interference suppression components on said printed circuit board, and
electrically contacting the leaf springs to at least one conductor track in each instance.

16. The method according to claim 15, wherein the printed circuit board is provided with solder pads, the solder pads are electrically contacted to a conductor track in each instance and the leaf springs are electrically contacted to the solder pads.

17. The method according to claim 16, wherein the leaf springs rest against the solder pads and are pressed against the respective solder pad by prestressing the respective leaf spring.

18. The method according to claim 15, wherein the leaf springs are made of springy sheet copper.

19. The method according to claim 15, wherein the punched contacts are made of an electrically conductive material.

20. The method according to claim 15, wherein the leaf springs are each fastened to punched contacts by means of a welded, screw or rivet connection.
